(19) United States
(12) Patent Application Publication
(10) Pub. No.: US 2017/0316354 A1
(43) Pub. Date: Nov. 2, 2017

(54) MANAGING INCIDENT WORKFLOW

(71) Applicant: Honeywell International Inc., Morristown, NJ (US)

(72) Inventors: Anantha Padmanabha Rahul U, Bangalore (IN); Deborah Learoyd, Columbier (CH); Simon C. Redvers, Chessington (GB); Rajkumar Palanivel, Bangalore (IN)

(21) Appl. No.: 15/142,680

(22) Filed: Apr. 29, 2016

(51) Int. Cl. G06Q 10/06

(52) U.S. Cl. CPC G06Q 10/0633

(57) ABSTRACT

Devices, methods, and systems for managing incident workflow are described herein. For example, one or more embodiments include a memory and a processor configured to execute executable instructions stored in the memory. The instructions are executable to receive information associated with a workflow response to an incident at a site, to generate a flow chart, based on the received information, to document a non-linear sequence of steps selectable in response to the incident, and to determine a total number of positive response pathways to reach a node of the workflow in the flow chart.

### TECHNICAL FIELD

The present disclosure relates to methods, devices, and systems related to managing incident workflow.

### BACKGROUND

Incidents, such as burglaries, fires, and/or medical emergencies, etc., can occur at or within buildings at any time. An incident can refer to any type of event that could lead to interruption and/or disruption of an organization's operations, services, and/or functions. If not properly responded to by a series of actions, such as a workflow, an incident may escalate into an emergency, crisis, and/or disaster.

An incident response workflow can refer to a process of limiting the potential interruption and/or disruption caused by an incident in order to contribute to returning an organization's operations, services, and/or functions to a normalized state (e.g., returning to business as usual). An incident workflow may include standard operating procedures that can be used to manage the incidents. A standard operating procedure may include a number of steps for a user to follow, such as, for instance, a sequence of actions to take during an incident and different standard operating procedures may be used to manage different types of incidents.

An incident management system may store information about incidents and/or the standard operating procedures used to manage workflows for those incidents, such as, for instance, the steps of a standard operating procedure. A cumulative complexity of the workflows may be increased by an organization possibly having varieties of types of facilities and/or of potential types of incidents at each facility at various sites.

### BRIEF DESCRIPTION OF THE DRAWINGS

FIGS. 1A-1 and 1A-2 is an illustration of a flow chart of an example of a workflow, in accordance with one or more embodiments of the present disclosure.

FIGS. 1B-1 and 1B-2 is an illustration of a flow chart of an example of a positive response pathway in a workflow, in accordance with one or more embodiments of the present disclosure.

FIG. 2 is an illustration of a display on a graphical user interface showing an example defined response pathway in a non-linear sequence of workflow steps, managed in accordance with one or more embodiments of the present disclosure.

FIG. 3 is an illustration of a display on a graphical user interface showing an example of creation of flow charts, in accordance with one or more embodiments of the present disclosure.

FIGS. 4A-4C are illustrations of a display on a graphical user interface showing examples of addition and deletion of steps in a workflow, in accordance with one or more embodiments of the present disclosure.

FIG. 5 is an illustration of a display on a graphical user interface showing an example of revision of steps in a workflow, in accordance with one or more embodiments of the present disclosure.

FIG. 6 is a system for managing a flow chart for an incident workflow, in accordance with one or more embodiments of the present disclosure.

### DETAILED DESCRIPTION

Devices, methods, and systems for managing incident workflow are described herein. For example, one or more embodiments include a memory and a processor configured to execute executable instructions stored in the memory. The instructions can be executable to receive information associated with a workflow response to an incident at a site, to generate, based on the received information, a flow chart to document a non-linear sequence of steps selectable in response to the incident, and to determine a total number of positive response pathways to reach a node of the workflow in the flow chart.

Managing an incident workflow, in accordance with previous approaches, that enables an appropriate response to a particular incident (e.g., fire), among many other possible types of incident at a site (e.g., a worksite, multi-dwelling unit, etc.), may be difficult because a workflow for each type of incident and/or at each site may be complex. For instance, each flow chart for the workflow with non-linear branching options (e.g., based on a yes/no decision) may be complex (e.g., as presented on an Excel spreadsheet). The complexity may make it difficult for a user (e.g., security manager and/or security operator) to create and/or for a responder (e.g., security staff, field staff, etc.) to understand. For example, this complexity may cause the user to spend much time during creation (e.g., design) of a flow chart to document a workflow for an incident in checking (e.g., repeatedly) to determine that each of the non-linear pathways in the flow chart is correct (e.g., leads to an intended outcome). Moreover, this complexity may make it difficult for the responder to identify which step is to be addressed and/or followed during the incident or even before the incident occurs.

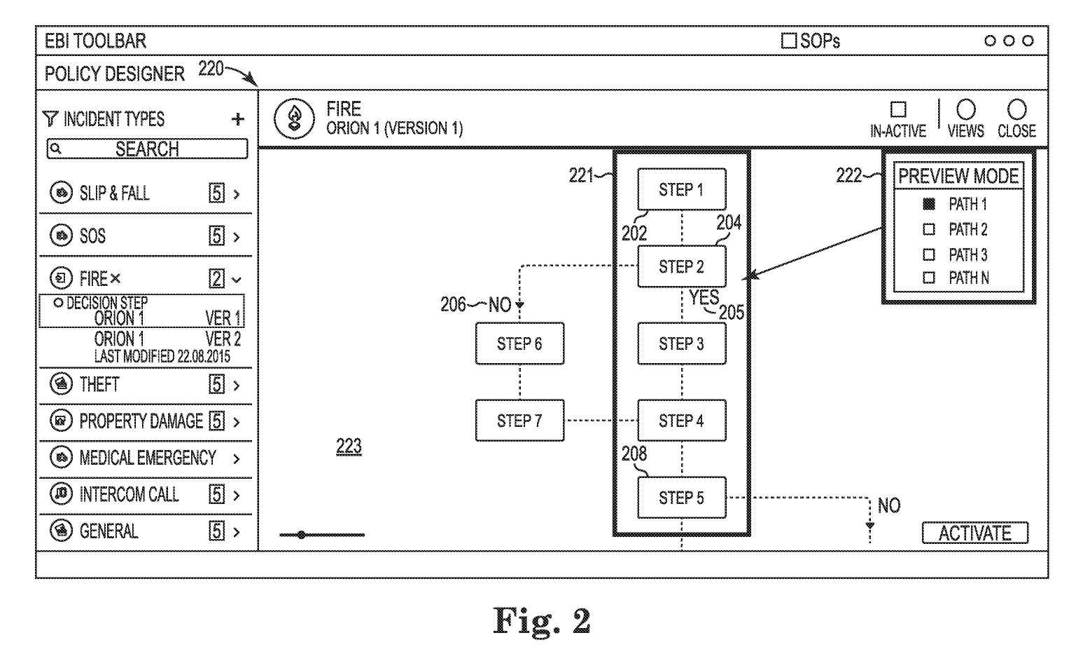

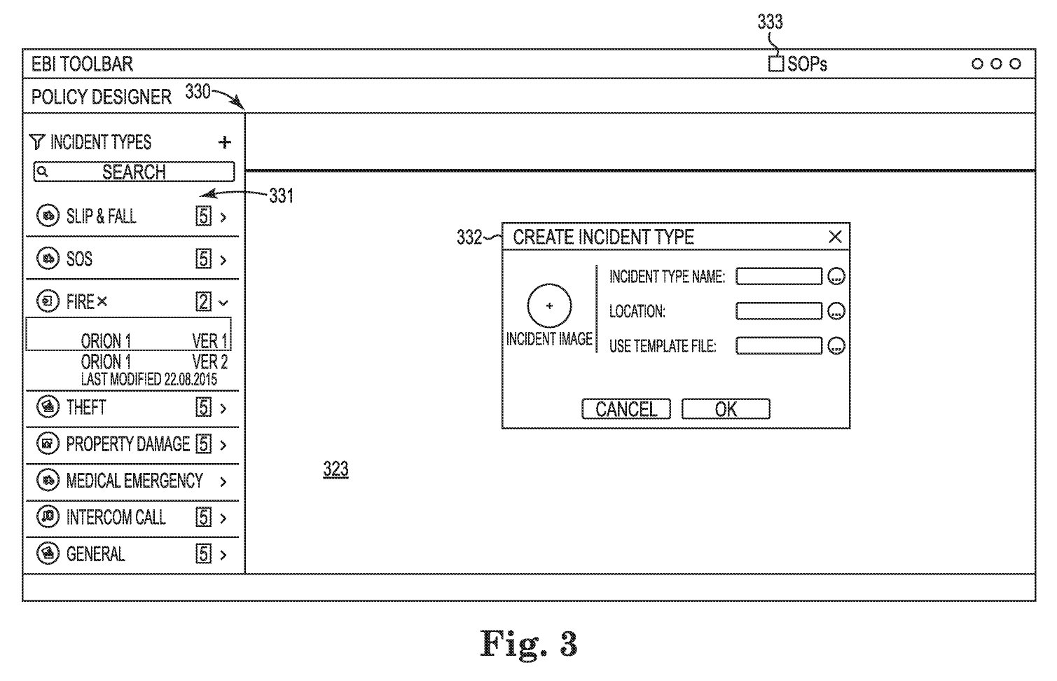

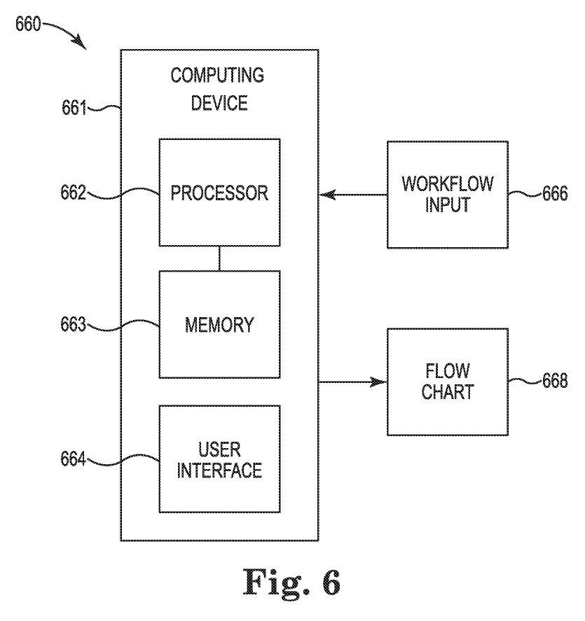

The present disclosure describes, in some embodiments, devices, methods, and/or systems for the creation, editing, addition, deletion, etc., of flow charts and/or steps in the workflow in the flow charts for various types of incidents and/or for various sites in order to make it easier for the user to manage incident workflows. For example, the user may create a new incident type called “Fire” in which steps of an intended workflow are presented in a non-linear format as a standard operating procedure (SOP) for response to fire at a particular site. Management of incident workflow having a non-linear sequence of workflow steps in a flow chart, as described herein, can be generated by a computing device (e.g., computing device 661 as described in connection with FIG. 6) in combination with an interactive graphical user interface (GUI) (e.g., as shown at 223 in FIG. 2 and at 323 in FIG. 3).

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing.

As used herein, “a” or “a number of” something can refer to one or more such things. For example, “a number of pathways” can refer to one or more pathways.

As used herein, an incident can refer to one or more events that occur at a site that may be associated with various forms of data. For example, an incident can be a burglary, and a number of door breakages can be events associated with the burglary. As another example, an incident can be a fire that has occurred, and a number of alarms can be events associated with the fire.

As used herein, a site can refer to a location where an incident has occurred. For example, a fire can occur in a server room of a building. The incident can be the fire that has occurred, whereas the site of the incident can be the server room of the building or an incident that occurs in another building.

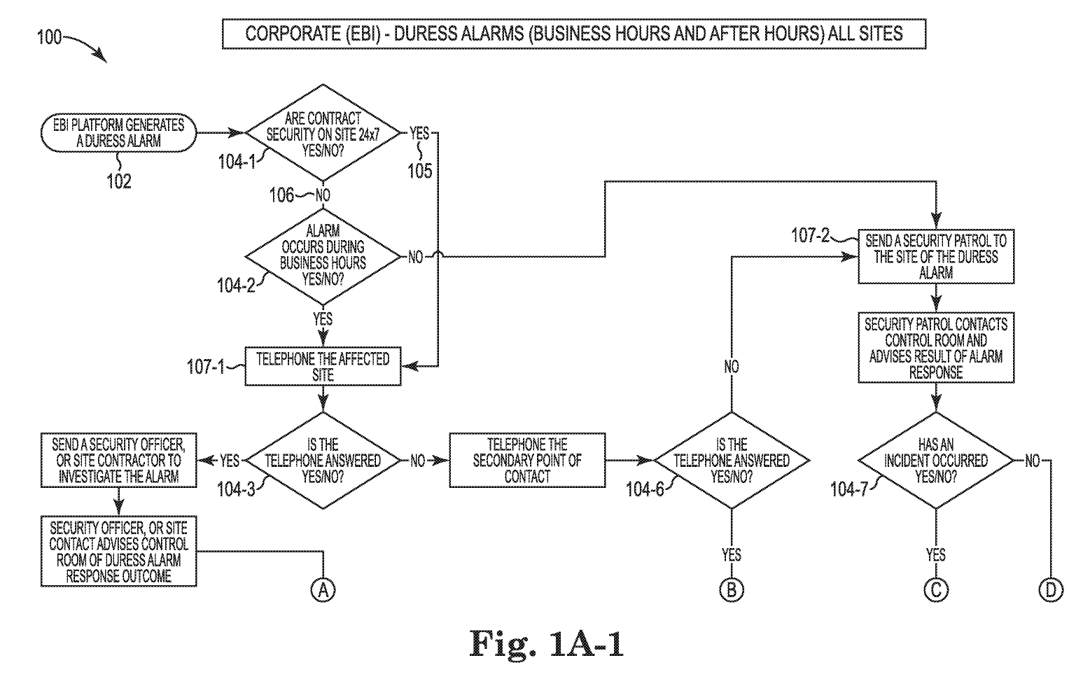

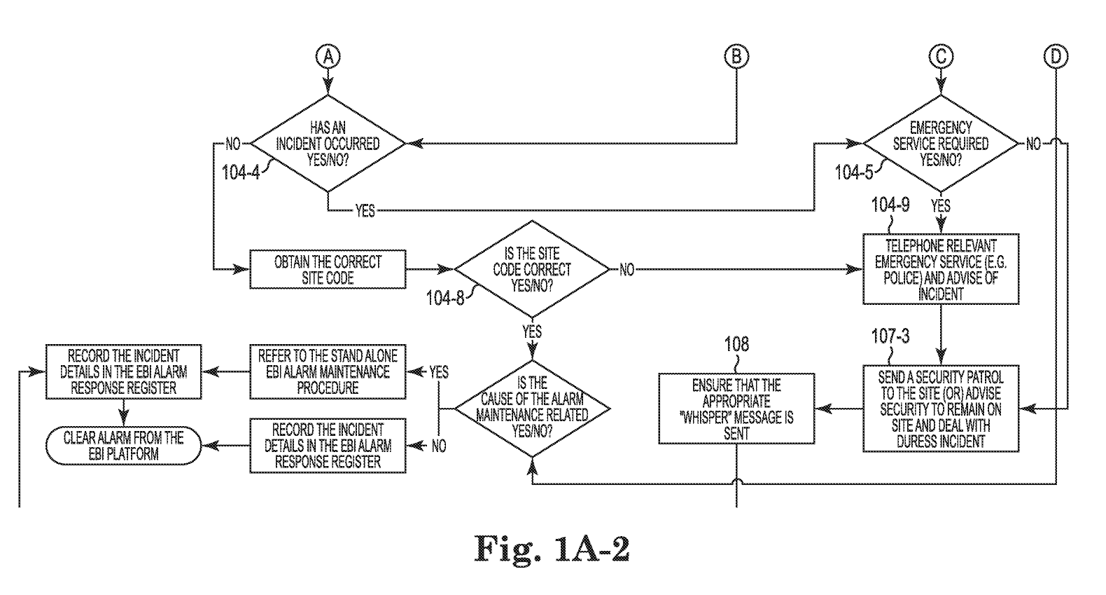

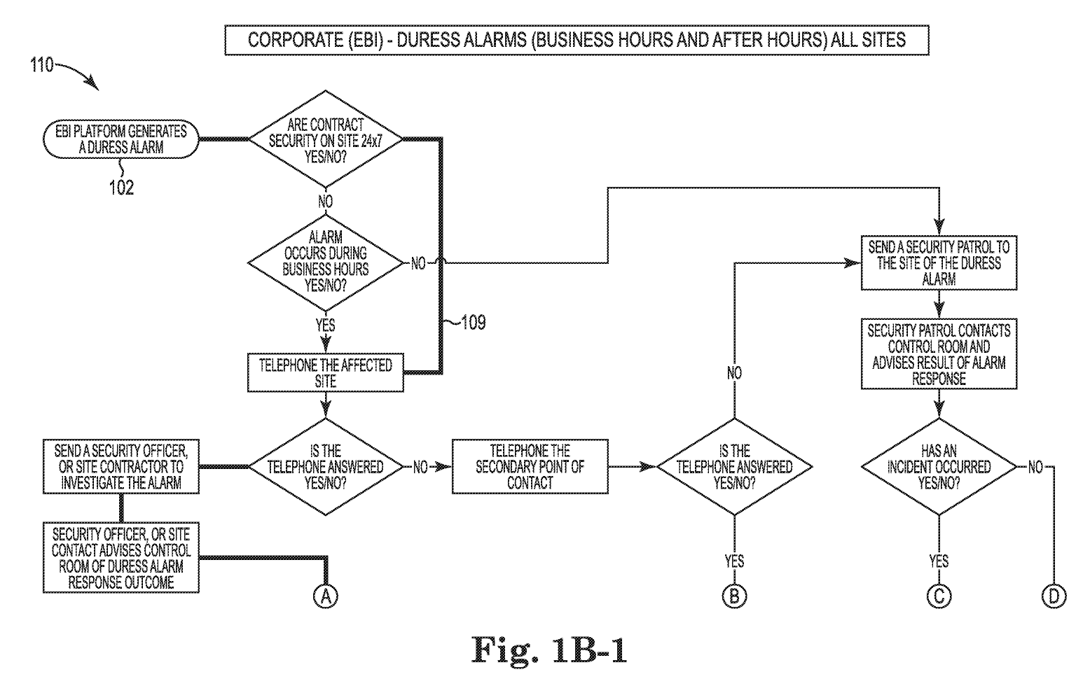

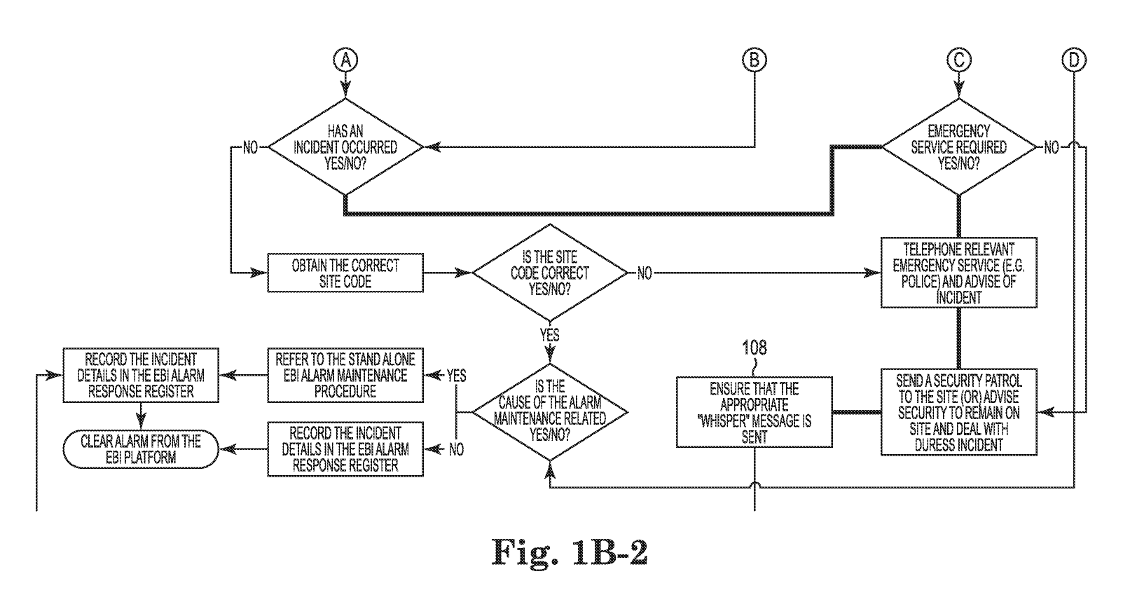

FIGS. 1A-1B are illustrations of flow charts of an example of a workflow, in accordance with one or more embodiments of the present disclosure. The example of the flow chart 100 illustrated in FIGS. 1A-1 and 1A-2 is intended to be considered with FIG. 1A-1 positioned vertically with respect to FIG. 1A-2. As such, the lines marked as A, B, C, and D at the bottom of FIG. 1A-1 are intended to match with the lines marked as A, B, C, and D at the top of FIG. 1A-2 to provide unbroken lines connecting the respective nodes. For example, the nodes for decision option 104-6 and decision option 104-4 can be linked through the lines marked B via a YES decision at the node for decision option 104-6.

By way of example, the flow chart 100 shown in FIGS. 1A-1 and 1A-2 illustrates an example of “duress alarms” during business hours and after business hours at “all sites” for a company, corporation, etc. However, embodiments of the present disclosure are not so limited. For example, flow charts may be related to specific types of incidents (e.g., fire, medical emergencies, theft, burglary, etc.) and/or to an incident at a particular site among a plurality of sites. In some embodiments, the flow chart shown in FIGS. 1A-1 and 1A-2 may illustrate a flow chart for a workflow (e.g., decisions and/or actions made in response to an incident) during creation by and/or after creation by a user (e.g., security manager and/or security operator), for example, interacting with a GUI. Examples of a GUI with which the user may interact to create (e.g., design) a flow chart for a workflow are shown at indicator number 223 in FIG. 2 and at indicator number 323 in FIG. 3.

As described herein, a non-linear sequence of steps is intended to mean a branching of a pathway in the flow chart into at least two possible pathways of steps (e.g., nodes) at a decision option. As presented in and described in connection with FIGS. 1A-1B, a decision option (e.g., at 104-1) may be at a node in the flow chart at which a YES decision 105 or a NO decision 106 may be made (e.g., selected). Selection of an option at a particular decision option may be performed by a user during creation of the workflow and/or by a responder based upon a situation at the incident and/or via execution of a workflow protocol stored in memory of a computing device, among other possible selectors. As described herein, each point in a flow chart at which a decision option is presented (e.g., at decision options 104-1 and 104-2, among others) and at which an action is described (e.g., at actions 102 and 107-1, among others) may be referred to as a “node”.

In some embodiments, the “action” may result from the decision option selected. For example, decision option 104-2 asks if the “alarm occurs during business hours” and presents the YES and NO options. If the alarm does occur during business hours, selection of the YES decision 105 instructs in action node 107-1 to “telephone the affected site”. In contrast, if the alarm does not occur during business hours, selection of the NO decision 106 instructs in action node 107-2 to “send a security patrol to the site of the duress alarm”.

As described herein, a “positive response pathway” is intended to mean at least two nodes for decision options in any portion of a flow chart at which a YES decision 105 is selected (e.g., YES being selected for both decision options 104-1 and 104-2). As such, a positive response pathway may be found for any node (e.g., the “first node” stated above) in a flow chart presenting a YES decision 105 as an option 104 and preceded by a YES decision at another decision option 104 and/or any action node 107 associated with such a selected YES response pathway.

The flow chart 110 shown in FIGS. 1B-1 and 1B-2 illustrates, by way of example, the same workflow shown in FIGS. 1A-1 and 1A-2 for the duress alarms at all sites for the corporation. Similar to FIGS. 1A-1 and 1A-2, the example flow chart 110 illustrated in FIGS. 1B-1 and 1B-2 is intended to be considered with FIG. 1B-1 positioned vertically with respect to FIG. 1B-2.

In some embodiments, a positive response pathway (e.g., as shown at 109 in FIGS. 1B-1 and 1B-2) may mean a pathway from a start point (e.g., at node 102) in an incident workflow at which YES is selected for all decision options 104 between the start point and an end point (e.g., node 108) in the incident workflow. A functionality (e.g., a button, scroll-down option, among other possibilities) may be actuated through the interactive GUI, for example, to cause an instruction to be executed such that a positive response pathway may be selected and/or displayed (e.g., highlighted) via interaction with a saved flow chart for an incident.

Similarly, a “negative response pathway” is intended to mean at least two nodes for decision options in any portion of a flow chart at which a NO 106 decision is selected (e.g., NO being selected for both decision options 104-1 and 104-2). A negative response pathway (not shown) may mean a pathway from a start point in the incident workflow (e.g., at node 102) at which NO is selected for all decision options between the start point and an end point in the incident workflow.

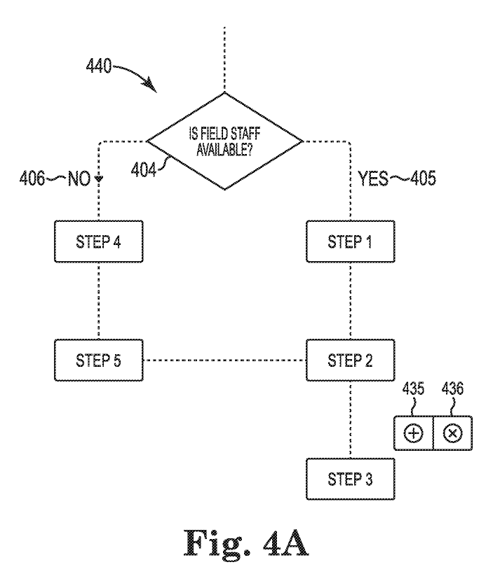

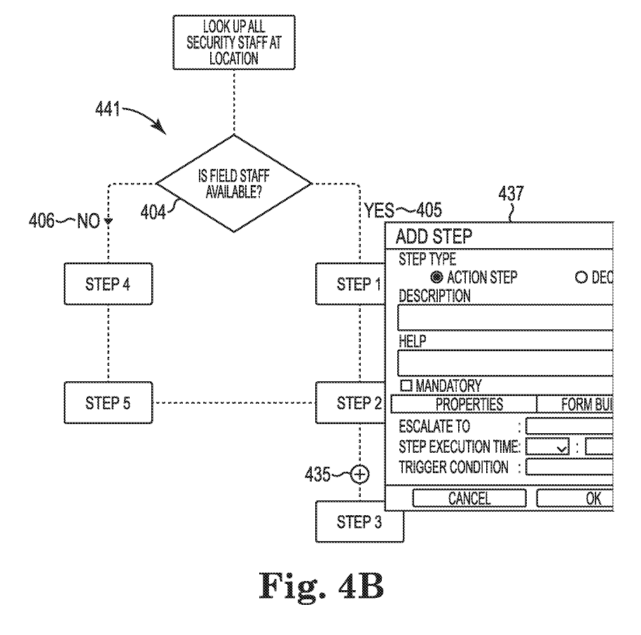

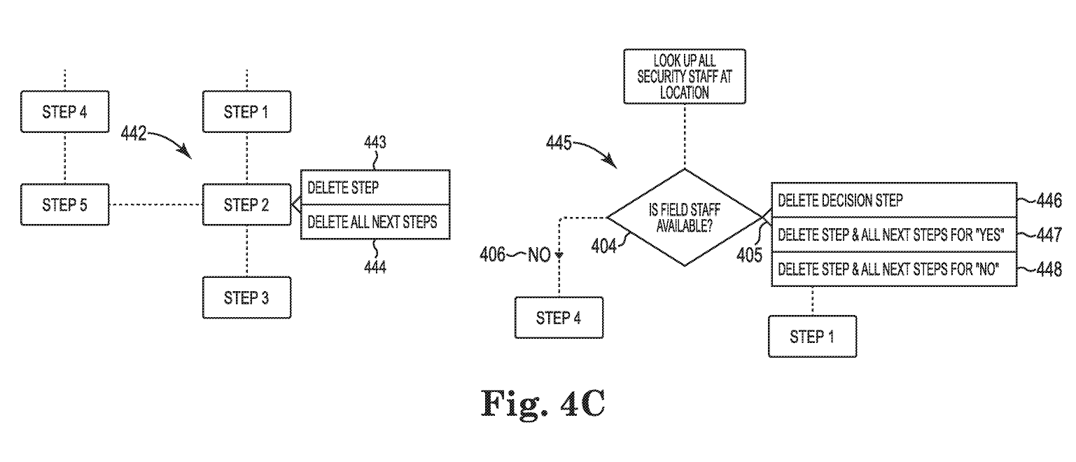

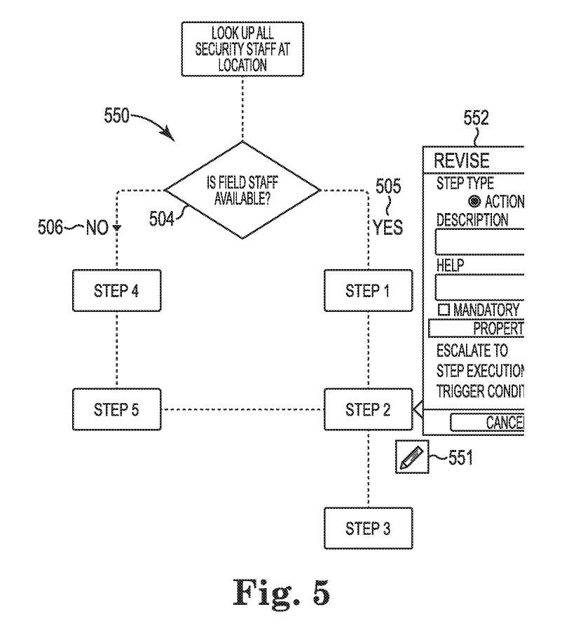

As described herein, flow charts may be saved (e.g., as a SOP indicated at 333 in FIG. 3) after acceptance (e.g., verification) by the user. Such verification may include and/or be preceded by editing, addition, deletion, revision, etc., of nodes in the flow charts, as described with reference to FIGS. 4A-4C and 5. Moreover, such flow charts may be accessed by responders (e.g., security staff, field staff, etc.) before and/or during the incident to visualize (e.g., on an Excel spreadsheet) the accepted SOP for responding to the incident.

FIG. 2 is an illustration of a display 220 on a GUI 223 showing an example of a defined (e.g., aggregated) response pathway 221. The aggregate response pathway 221 may include a decision option 204, in a non-linear sequence of workflow steps, managed in accordance with one or more embodiments of the present disclosure. The non-linearity of the selectable sequence of steps is indicated by decision option 204 being within the aggregate response pathway 221.

The aggregate response pathway 221 may, for example, be a positive response pathway that includes a YES decision 205 being made for the decision option 204. The aggregate response pathway 221 begins 202 at Step 1 and ends 208 at Step 5. The positive response pathway shown between Step 1 and Step 5 in FIG. 2 may, for example, correspond to the positive response pathway 109 highlighted in FIGS. 1B-1 and 1B-2 that begins at start point 102 and ends at end point 108 or may correspond to a portion thereof. By being a positive response pathway, Step 1, Step 3, Step 4, and/or Step 5 in the aggregate response pathway 221, if any or all were decision options, would have a YES decision 205 being made, as shown for the decision option 204. In contrast, if a NO decision 206 were made for the decision option 204, Step 6 and Step 7, for example, would not be included in the aggregate response pathway 221, as shown in FIG. 2.

As indicated at the Preview Mode 222, various pathways and/or portions of pathways (e.g., positive response pathways, negative response pathways, and portions and/or combinations thereof) may be selected by a user and/or responder to be displayed 220 on the interactive GUI 223. Such selections may be made by the user during creation of a flow chart and/or by a responder before and/or during response to an incident for which the flow chart is the SOP.

Implementation of the devices, methods, and systems for managing incident workflow described herein can, for example, enable users and/or responders to highlight (e.g., as shown at 109 in FIGS. 1B-1 and 1B-2) and/or aggregate (e.g., as shown at 221 in FIG. 2) a positive response pathway from a start point to an end point of an incident response workflow, or any portion within the incident response workflow. Negative response pathways may be similarly highlighted and/or aggregated. Presenting the pathways as such may provide a clearer picture to the user during creation of the flow chart, which may simplify verification thereof prior to saving the flow chart as an SOP. In addition, presenting the pathways as such may provide simplified and/or clearer courses of action to be considered by the responders before and/or during an incident workflow.

Accordingly, the user and/or responder may be allowed to more quickly gain an overall view and/or a focused view of an incident response pathway by automated highlighting and/or aggregating complete response pathways or various portions of pathways associated with various types of incidents and/or sites. Automated pathway highlighting and/or aggregation as such may notably reduce an amount of time and/or effort involved in creation of and/or following a flow chart for an incident. Flow charts accessible as such may enable a responder to respond more quickly to an incident, such as for preventing and/or stopping progression of the incident, among many other proactive and/or reactive responses to the incident. Additionally, these type of flow charts may allow responders associated with an incident response to more clearly visualize response pathways to, for example, enable focused suggestions for more efficient responses to future incidents and/or to enable focused suggestions for corrective measures to reduce likelihood of a similar incident occurring in the future.

Accordingly, a computing device, including a memory and a processor configured to execute executable instructions stored in the memory (e.g., as shown and described in connection with FIG. 6), can be configured for management of an incident workflow, as described herein. In some embodiments, the computing device can be configured to receive information (e.g., the decision options and/or associated action steps shown and described in connection with FIGS. 1A-1 and 1A-2) associated with a workflow response to an incident at a site (e.g., as shown at 332 and described in connection with FIG. 3 and at 666 and described in connection with FIG. 6) and generate a flow chart, based on the information, to document a non-linear (e.g., branching) sequence of steps selectable in response to the incident (e.g., as shown at 100 and described in connection with FIGS. 1A-1 and 1A-2 and at 668 and described in connection with FIG. 6). In some embodiments, the computing device can be configured to determine a total number of positive response pathways (e.g., as shown at 109 and described in connection with FIGS. 1B-1 and 1B-2) to reach a node of the workflow in the flow chart.

In some embodiments, the node of the workflow may be any particular node between a particular start point (e.g., at node 102 in FIGS. 1A-1 and 1B-1, although a start point may be any other node) and a particular end point (e.g., at node 108 in FIGS. 1A-2 and 1B-2, although an end point may be any node subsequent to the start point) of the workflow in response to the incident. In some embodiments, the node of the workflow may be at the end point (e.g., node 108) of the workflow in response to the incident. The total number of positive response pathways to reach the first node of the workflow may, in some embodiments, be one positive response pathway. For example, selecting a YES decision at each decision option in the positive response pathway 109 highlighted in FIGS. 1B-1 and 1B-2 yields one positive response pathway.

In some embodiments, the computing device can be configured to determine a total number of negative response pathways to reach what may be another node of the workflow in the flow chart. For example, selecting a NO decision at each decision option in FIGS. 1A-2 and 1B-2 between a particular start point and a particular end point can yield a negative response pathway (not shown) to the second node. The total number of negative response pathways to reach the second node of the workflow may, in some embodiments, be one negative response pathway. For example, similar to selecting the YES decision at each decision option in the positive response pathway 109, selecting a NO decision may yield one negative response pathway.

As such, in some embodiments, there may be only one positive response pathway determined by selecting all YES decisions and only one negative response pathway determined by selecting all NO decisions in response to decision options. Nonetheless, the positive response pathway and/or the negative response pathway may be of particular interest to a user and/or a responder when managing the incident workflow.

In some embodiments, the computing device can be configured to determine a total number of pathways that includes at least one positive response and at least one negative response in order to reach what may be another node of the workflow in the flow chart. For example, such a total number of pathways can be determined by a total number of pathways that include at least one YES decision being selected at a decision option and at least one NO decision being selected at another decision option.

Workflows may be complex (e.g., as illustrated on flow chart 100 shown in FIGS. 1A-1 and 1A-2). As such, it may be difficult for a user and/or responder to identify each different pathway and/or how many different pathways may be followed in a flow chart. Hence, determining all the positive response pathways, negative response pathways, and/or those that include at least one positive response and at least one negative response enables identification of some or all of the different potential pathways. In some embodiments, some or all of the different potential pathways may be selectably defined (e.g., displayed) as a sequence of steps within an aggregate response pathway (e.g., as shown at 221 and described in connection with FIG. 2) and/or selectably highlighted as a pathway in a flow chart (e.g., as shown at 109 and described in connection with FIGS. 1B-1 and 1B-2). As such, a user and/or responder may be able to view some or all of the different possible pathways to reach a particular node.

In some embodiments, the nodes described above may all be the same node. For example, a particular node within the flow chart may be reachable by following separate pathways. For instance, the particular node may be reachable by following a number of pathways that each include at least one positive response and at least one negative response and by following at least one positive response pathway and/or at least one negative response pathway, among other possible combinations.

FIG. 3 is an illustration of a display 330 on a GUI 323 showing an example of creation of flow charts per incident type 331, in accordance with one or more embodiments of the present disclosure. A user (e.g., security manager and/or security operator) may interact with the GUI 323 to select a particular incident type 331 (e.g., Fire), a particular version (e.g., Orion 1) and/or a particular site (not shown) to input workflow parameters (e.g., as shown at 666 in FIG. 6) to edit (e.g., add, delete, and/or revise) preexistent nodes and/or text thereof in a flow chart (e.g., a SOP 333). Alternatively or in addition, the user may create a new flow chart (e.g., as shown at 100 and described in connection with FIG. 1) and/or a new incident type 331. In either case, instructions regarding workflow parameters may be input (e.g., as shown at 666 in FIG. 6) through an interactive icon 332 on the GUI 323 of the display 330. Other examples of such interactive icons on the GUI of the display are shown at 435-437 in FIGS. 4A-4B, at 443-444 and 446-448 in FIG. 4C, and/or at 551-552 in FIG. 5.

FIGS. 4A-4C are illustrations of a display on a GUI for examples of addition and deletion of steps in a workflow, in accordance with one or more embodiments of the present disclosure. In FIG. 4A, decision option 404 of workflow 440 asks, for example, “is field staff available?” Selecting the YES decision 405 of the non-linear sequence of steps causes progression on the branched pathway from Step 1 through Step 3, and possibly on to additional steps. Selecting the NO decision 406 of the non-linear sequence of steps causes progression on the branched pathway from Step 4 to Step 5, followed by merger with Step 2 of the positive response pathway, and possibly on to the additional steps.

A user may edit such pathways by adding and/or deleting nodes and/or text thereof. For example, selecting (e.g., clicking on) an ADD icon 435 may connect to an edit mode that enables adding a number of steps (e.g., nodes) to the workflow 441, as described further in connection with FIG. 4B. Selecting (e.g., clicking on) a DELETE icon 436 may connect to an edit mode that enables deleting a number of steps (e.g., nodes) from the workflow 441, as described further in connection with FIG. 4C.

In FIG. 4B, for example, a positive response branch of workflow 441 can be enabled by selection of the YES decision 405. To add a step (e.g., a node) between two preexistent steps (e.g., nodes) of the positive response branch, an ADD icon 435 may be selected between the appropriate steps (e.g., Step 2 and Step 3). Selecting the ADD icon 435 may cause an interactive ADD STEP icon 437 to appear on the display. Appropriate information (e.g., as to whether the added step is a decision option or an action type of step) and/or descriptive text may be entered into various fields in the interactive ADD STEP icon 437. After the appropriate information and/or text is entered into the interactive ADD STEP icon 437, the user may accept (e.g., by clicking on an OK button), which may cause a new node to appear between the two preexistent nodes of the positive response branch (e.g., between Step 2 and Step 3).

As illustrated in FIG. 4C, a user may delete a number of steps (e.g., nodes) from a pathway of a workflow 442. For example, the positive response branch that can be enabled by selection of the YES decision 405 described in connection with FIG. 4B may have action Step 2 deleted. Selecting a DELETE icon 436 associated with action Step 2 may, for example, cause a number of additional icons to appear on the display that enable selection of various options (e.g., by clicking on an appropriate icon) that determine what is to be deleted. For example, for action Step 2, the options may be an icon 443 that just causes action Step 2 to be deleted and/or an icon 444 that causes all the next steps after action Step 2 to be deleted. Both icon 443 and icon 444 may be selected to cause action Step 2 and all the next steps after action Step 2 to be deleted. In some embodiments, appropriate selection from action nodes and/or decision option nodes may be made in the next steps to be deleted. By deleting these steps, the associated nodes are also deleted from the flow chart.

As illustrated in FIG. 4C, a user may delete a decision option step in a pathway of a workflow 445. For example, decision option 404 may be selected by an associated DELETE icon 436. Selecting the DELETE icon 436 associated with decision option 404 may, for example, cause a number of additional icons to appear on the display that enable selection of various options (e.g., by clicking on an appropriate icon) that determine what is to be deleted. For example, for decision option 404, the options may be an icon 446 that just causes decision option 404 to be deleted, an icon 447 that causes decision option 404 and all of the next steps for the positive response branch enabled by selection of the YES decision 405 to be deleted, and/or an icon 448 that causes decision option 404 and all of the next steps for the negative response branch enabled by selection of the NO decision 406 to be deleted. Both icon 447 and icon 448 may be selected to cause decision option 404 and all the next steps in the positive and negative response branches to be deleted.

FIG. 5 is an illustration of a display on a GUI showing an example of revision of steps in a workflow, in accordance with one or more embodiments of the present disclosure. In FIG. 5, a positive response branch, for example, of workflow 550 can have revision of the text of Step 2 enabled by selection of a REVISE icon 551. Selecting the REVISE icon 551 associated with action Step 2 may, for example, cause an additional icon 552 to appear on the display that enables the text of the node for Step 2 to be revised. Revising the text of a decision option node (e.g., as shown at 504) may be performed similarly.

Accordingly, managing an incident workflow, as described herein, can be implemented by a computing device (e.g., as shown at 661 and described in connection with FIG. 6). The incident workflow may, in some embodiments, be implemented by receiving information (e.g., the decision options and/or associated action steps shown and described in connection with FIGS. 1A-1 and 1A-2) associated with steps of a workflow response to an incident at a site (e.g., as shown at 332 and described in connection with FIG. 3 and at 666 and described in connection with FIG. 6) and generating, based on the received information, a flow chart of non-linear steps selectable in response to occurrence of the incident (e.g., as shown at 100 and described in connection with FIGS. 1A-1 and 1A-2 and at 668 and described in connection with FIG. 6). Managing the incident workflow may further include enabling access by a user to the flow chart of non-linear steps (e.g., as shown at display 220, 330 on GUI 223, 323 and described in connection with FIGS. 2 and 3 and as shown at user interface 664 and described in connection with FIG. 6) and/or a view of some or all possible response pathways to reach a particular node of the workflow.

In some embodiments, managing the incident workflow may include receiving information associated with steps of a plurality of workflow responses. At least some of a plurality of workflow responses may be individually intended as SOPs to particular types of incidents (e.g., as shown at 331 and 333 and described in connection with FIG. 3). For example, each of the plurality of workflow responses may individually correspond to a respective plurality of incident types at the site (e.g., one workflow response per incident type at the site). Alternatively or in addition, each of the plurality of workflow responses may individually correspond to an incident at a respective plurality of sites. For example, one or more workflow response may be individually associated with each of a plurality of sites. Each of the workflow responses may, in some embodiments, correspond to a particular incident type and/or workflow response version at a particular site.

Managing the workflow may include receiving, from a user of the computing device, the information associated with steps of the workflow (e.g., as shown at 332 and described in connection with FIG. 3) and presenting, to the user of the computing device, the flow chart of selectable non-linear steps (e.g., as shown in flow chart 100 at decision options 104-1, 104-2, etc., and described in connection with FIGS. 1A-1 and 1A-2) and/or a view of some or all possible response pathways to reach a particular node of the workflow. In some embodiments, the flow chart is presented on an interactive GUI (e.g., as shown at 223 in FIG. 2 and at 323 in FIG. 3).

The flow chart of the selectable non-linear steps may be presented to the user of the computing device to enable the user to verify (e.g., by acceptance, for instance as an SOP) that the flow chart presents an intended workflow for response to the incident at the site. Such verification by the user may involve examination and/or editing of a number of the determined positive response pathways, negative response pathways, and/or those that include at least one positive response and at least one negative response. The pathways may be verified individually because each path may be individually identified and/or presented to the user.

As described with regard to FIGS. 4A-4C and 5, the user may edit a pathway of the flow chart of selectable non-linear steps by entry of an edit via an interactive GUI. As described herein, the edit may be to selectably add, delete, and/or revise a step of the flow chart. After determination that that the flow chart presents the intended workflow, the verified workflow of selectable non-linear steps may be saved as a SOP for the response to the incident at the site.

FIG. 6 is a system 660 for managing a flow chart 668 for an incident workflow, in accordance with one or more embodiments of the present disclosure. As shown in FIG. 6, system 660 can include a computing device 661. Computing device 661 can include a memory 663 and a processor 662 configured to generate the flow chart 668 based on workflow input 666 (e.g., from a user, as described herein).

The memory 663 can be any type of storage medium that can be accessed by the processor 662 to perform various examples of the present disclosure. For example, the memory 663 can be a non-transitory computer readable medium having computer readable instructions (e.g., computer program instructions) stored thereon that are executable by the processor 662 to generate a flow chart 668 for an incident workflow in accordance with the present disclosure. Further, processor 662 can execute the executable instructions stored in memory 663 to generate the flow chart 668 for the incident workflow in accordance with the present disclosure.

The memory 663 can be volatile or nonvolatile memory. The memory 663 can also be removable (e.g., portable) memory, or non-removable (e.g., internal) memory. For example, the memory 663 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 663 is illustrated as being located within computing device 661, embodiments of the present disclosure are not so limited. For example, memory 663 can also be located internal to another computing resource (e.g., enabling computer readable instructions to be downloaded over the Internet or another wired or wireless connection).

The system 660 for generating the flow chart 668 for the incident workflow may include a user interface 664 (e.g., as shown at display 220, 330 on GUI 223, 323 and described in connection with FIGS. 2 and 3) coupled to the computing device 661. A user (e.g., security manager and/or security operator) of computing device 661 can interact with computing device 661 via the user interface 664. For example, the user interface 664 can provide (e.g., display and/or present) information to the user of computing device 661 and/or receive workflow input 666 from (e.g., input by) the user of computing device 661. The workflow input 666 may be input by, for example, creation, editing, addition, deletion, revision, etc., of nodes and/or steps in the workflow in the flow charts (e.g., as shown in and described in connection with FIGS. 2-5).

In some embodiments, the user interface 664 can be a GUI that includes a display (e.g., a screen) that can provide and/or receive information to and/or from the user of computing device 661. The display can be, for instance, a touch-screen (e.g., the GUI can include touch-screen capabilities). Alternatively, a display can include a television, computer monitor, mobile device screen, or other type of display device connected to computing device 661 and configured to receive a video signal output from the computing device 661. As an additional example, the user interface 664 can include a keyboard and/or mouse that the user may use to input information into computing device 661. Embodiments of the present disclosure, however, are not limited to a particular type(s) of user interface.

As shown in FIG. 6, computing device 661 can receive the workflow input 666 and, in some embodiments, receive a number of other user inputs via the user interface 664. Computing device 661 can further generate a flow chart 668 of selectable non-linear steps (e.g., decision options) and/or action steps in a workflow to be followed by responders in response to an incident (e.g., as a SOP for a particular type of incident and/or an incident at a particular site) that is displayable to the user and/or responder via a user interface 664. Further, computing device 661 can export the workflow input 666 and/or the flow chart 668 of the incident for use (e.g., creation, editing, addition, deletion, revision, etc., of nodes and/or steps in the flow chart) by the user of computing device 661 and/or another user.

The system 660 described in connection with FIG. 6 may be configured to execute a non-transitory computer readable medium (CRM) having computer readable instructions (CRI) stored thereon. The CRI may be executable by a processor in order to receive information associated with a workflow response to an incident at a site, generate a flow chart to document a sequence of steps that include a number of non-linear decision options selectable (e.g., by a responder) in response to the incident, and determine a number of pathways in the flow chart to reach a second node in the flow chart from a first node in the flow chart.

The first node in the flow chart may be a first node of the workflow and the second node in the flow chart may be a last node of the workflow. In some embodiments, the first node may correspond to an action node (e.g., shown at 102 in FIG. 1A-1) and the last node may be another action node (e.g., shown at 108 in FIG. 1A-2). In some embodiments, the first node and the second node may correspond to non-linear selectable decision options (e.g., shown at 104-1 and 107-3 in FIGS. 1A-1 and 1A-2, respectively). The first node may be an action node and the second node may be a decision option node, or vice versa. The first node in the flow chart may be between a first non-linear selectable decision option and a last non-linear selectable decision option in the flow chart (e.g., at any action node or decision option node between the first and last decision option node).

The system 660 may execute the CRI to determine a number of steps in each of the pathways in the flow chart that reach the second node in the flow chart from the first node in the flow chart. The CRI may be executed to, for example, select from each of the pathways a particular pathway that has a fewest number of steps to reach the second node from the first node. A shortest pathway (e.g., the pathway having the fewest number of steps) may be displayed to a user and/or a responder on a GUI. In some embodiments, a pathway (e.g., a positive response pathway) may be displayed to the user and/or the responder on a GUI to reach the second node from the first node based on positive responses to each of a number of non-linear decision options from the first node to the second node. Examples of such positive response pathways are shown at 109 and described in connection with FIGS. 1B-1 and 1B-2 and/or at 221 and described in connection with FIG. 2. As described herein, negative response pathways may be similarly displayed, as can pathways including at least one positive response and at least one negative response

The system 660 may execute the CRI to import data associated with an ongoing incident at a site. Such data may include a position in the flow chart of the workflow response to the incident. For example, the particular node to which the workflow response has progressed (e.g., by action or inaction of a responder) at the site may be the position in the flow chart provided for import to the system. Based upon this position, the system may determine a number of remaining pathways in the flow chart that are possible to follow to reach another node in the flow chart (e.g., an end point, such as node 108, in the incident workflow). The system 660 may execute the CRI to export data including the number of remaining pathways to the site (e.g., for consideration of remaining options by the responders). In some embodiments, the CRI may be configured to provide a recommendation of a suggested pathway (e.g., a shortest pathway) selected from the number of remaining pathways.

Managing an incident workflow, as described herein, may be usable as an improved security system tool that may be implemented to expedite creation and/or editing of incident workflows to various types of incidents and/or for incidents at various sites. Workflows created and/or edited as such may be verified for accuracy and/or ability to achieve an intended outcome prior to being deployed for use in response to a particular type of incident and/or an incident at a particular site. Moreover, workflows presented to a responder as described herein may be easier to follow in progression toward an intended outcome in response to the incident.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for management of an incident workflow, comprising:
a memory;
a processor configured to execute executable instructions stored in the memory to:
receive information associated with a workflow response to an incident at a site;
generate a flow chart, based on the received information, to document a non-linear sequence of steps selectable in response to the incident; and
determine a total number of positive response pathways to reach a node of the workflow in the flow chart.

2. The computing device of claim 1, wherein the total number of positive response pathways to reach the node of the workflow is one positive response pathway.

3. The computing device of claim 1, wherein the node of the workflow is at an end point of the workflow in response to the incident.

4. The computing device of claim 1, wherein the node of the workflow is between a start point and an end point of the workflow in response to the incident.

5. The computing device of claim 1, wherein the processor is configured to execute the instructions to:
determine a total number of negative response pathways to reach an additional node of the workflow in the flow chart.

6. The computing device of claim 1, wherein the processor is configured to execute the instructions to:
determine a total number of pathways that include at least one positive response and at least one negative response in order to reach an additional node of the workflow in the flow chart.

7. A computer implemented method for managing an incident workflow, comprising:
receiving, by a computing device, information associated with steps of a workflow response to an incident at a site;
generating, by the computing device based on the received information, a flow chart of non-linear steps selectable in response to occurrence of the incident;
enabling, by the computing device, access by a user to the flow chart of non-linear steps; and
enabling, by the computing device, access by the user to view all possible response pathways to reach a node of the workflow in the flow chart.

8. The method of claim 7, including receiving information associated with steps of a plurality of workflow responses, each of the plurality of workflow responses to a respective plurality of incident types at the site.

9. The method of claim 7, including receiving information associated with steps of a plurality of workflow responses, each of the plurality of workflow responses to an incident at a respective plurality of sites.

10. The method of claim 7, wherein the method includes:
receiving, from the user of the computing device, the information associated with the steps of the workflow; and
presenting, to the user of the computing device, the flow chart of non-linear steps and all possible response pathways to reach the node of the workflow in the flow chart; and
wherein the flow chart and all the possible pathways are presented on an interactive graphical user interface.

11. The method of claim 7, wherein the method includes:
enabling verification, by the user, that the flow chart of the non-linear steps presents an intended workflow for response to the incident at the site; and
saving a verified workflow of selectable non-linear steps as a standard operating procedure for the response to the incident at the site.

12. The method of claim 7, wherein:
enabling the access to the flow chart of non-linear steps includes enabling the user to edit a response pathway of the flow chart of non-linear steps by entry of an edit via an interactive graphical user interface.

13. The method of claim 12, wherein enabling the user to edit the flow chart includes enabling the user to selectably add, delete, or revise a step of the flow chart.

14. A non-transitory computer readable medium having computer readable instructions stored thereon that are executable by a processor to:
receive information associated with a workflow response to an incident at a site;
generate, based on the received information, a flow chart to document a sequence of steps that include a number of non-linear decision options selectable in response to the incident; and
determine a number of pathways in the flow chart to reach a second node in the flow chart from a first node in the flow chart.

15. The computer readable medium of claim 14, wherein:
the first node in the flow chart is a first node of the workflow and the second node in the flow chart is a last node of the workflow; and
the first node and the second node are non-linear selectable decision options.

16. The computer readable medium of claim 14, wherein:
the first node in the flow chart is between a first non-linear selectable decision option and a last non-linear selectable decision option in the flow chart.

17. The computer readable medium of claim 14, wherein the computer readable instructions are executable to:
determine a number of steps in each of the pathways in the flow chart that reach the second node in the flow chart from the first node in the flow chart.

18. The computer readable medium of claim 17, wherein the computer readable instructions are executable to:
select from each of the pathways a pathway that has a fewest number of steps to reach the second node from the first node.

19. The computer readable medium of claim 14, wherein the computer readable instructions are executable to:
display, on a graphical user interface, a pathway to reach the second node from the first node based on positive responses to each of a number of non-linear decision options from the first node to the second node.

20. The computer readable medium of claim 14, wherein the computer readable instructions are executable to:
import data associated with an ongoing incident at the site, wherein the data includes a position in the flow chart of the workflow response to the incident;
determine a number of remaining pathways from the position in the flow chart to reach another node in the flow chart from the position in the flow chart; and
export data including the number of remaining pathways to the site.
